(19) United States
(12) Patent Application Publication
(10) Pub. No.: US 2023/0100489 A1
(43) Pub. Date: Mar. 30, 2023

(54) MIRROR DISPLAY DEVICE, IMAGE DISPLAY METHOD, ELECTRONIC DEVICE AND STORAGE MEDIUM

(71) Applicants: Beijing BOE Technology Developments Co., Ltd., Beijing (CN); BOE Technology Development Co., Ltd., Beijing (CN)

(72) Inventors: Wenbo LI, Beijing (CN); Lijie ZHANG, Beijing (CN)

(73) Assignees: Beijing BOE Technology Development Co., Ltd., Beijing (CN); BOE Technology Development Co., Ltd., Beijing (CN)

(21) Appl. No.: 17/909,990

(22) PCT Filed: Jun. 11, 2021
(86) PCT No.: PCT/CN2021/099809

§ 371 Date: Sep. 8, 2022

(30) Foreign Application Priority Data
Jun. 16, 2020 (CN) 202010547468.8

(51) Int. Cl. G02F 1/137; G06T 7/12; G06T 7/194; G06T 7/174; G02F 1/133

(52) U.S. Cl. CPC G02F 1/137; G06T 7/12; G06T 7/194; G06T 7/174; G02F 1/13306; G02F 2203/09; G02F 2201/08; G06T 2207/20224

(57) ABSTRACT

The present disclosure relates to a mirror display device, an image display method, an electronic device and a storage medium are provided and related to the technical field of optics. The mirror display device comprises: an optical switch array (101) comprising multiple optical switches, the optical switches being used for obtaining, in a first state, a first light beam based on incident light; a reflection layer (102) arranged on one side of the optical switch array (101) and used for receiving and reflecting the first light beam incident to the reflection layer (102); and a control module (103) for determining a reflection region and a non-reflection region, controlling the optical switch corresponding to the reflection region to be in the first state, and controlling the optical switch corresponding to the non-reflection region to be in a second state that is different from the first state.

### CROSS-REFERENCE TO RELATED APPLICATIONS

The present application is the 371 application of PCT Application No. PCT/CN2021/099809, filed on Jun. 11, 2021, which is based upon and claims the priority to the Chinese Patent Application NO. 202010547468.8, entitled “MIRROR DISPLAY DEVICE, IMAGE DISPLAY METHOD, ELECTRONIC DEVICE AND STORAGE MEDIUM”, filed on Jun. 16, 2020, the entire contents of which are hereby incorporated by reference.

### TECHNICAL FIELD

The present disclosure relates to the field of optical technologies, and in particular, to a mirror display device, a method for displaying an image, an electronic device, and a computer-readable storage medium.

### BACKGROUND

When an ordinary mirror displays a mirror image of a current scene, a mirror effect is achieved by reflecting light. In general, a whole area on the mirror that displays the mirror image is a reflection area, and there are no non-reflection areas. Even if a part of the mirror is blocked to achieve the non-reflection area, the non-reflection area is fixed and cannot be dynamically adjusted according to a change in the mirror image, and the ordinary mirror cannot discriminately display target objects in the mirror image.

Due to the above-mentioned shortcomings of the ordinary mirror, a way of presenting the mirror effect through a display device is increasingly popular for people. At present, in related technical solutions, the display device acquires an image through a camera, and optimizes the image to display it on a display screen to present the image with the mirror effect.

It should be noted that the information disclosed in the Background section above is only for enhancing the understanding of the background of the present disclosure, and thus may include information that does not constitute prior art known to those of ordinary skill in the art.

### SUMMARY

Embodiments of the present disclosure provide a mirror display device, a method for displaying an image, an electronic device, and a computer-readable storage medium.

According to a first aspect of the embodiments of the present disclosure, there is provided a mirror display device, including: an optical switch array, including a plurality of optical switches configured to obtain, in a first state, a first light beam based on incident light; a reflection layer, disposed on a side of the optical switch array, and configured to receive and reflect the first light beam incident on the reflection layer; and a control module, configured to determine a reflection area and a non-reflection area, and control an optical switch corresponding to the reflection area to be in the first state, and an optical switch corresponding to the non-reflection area to be in a second state different from the first state.

According to a second aspect of the embodiments of the present disclosure, there is provided a method for displaying an image, which is applied to a mirror display device including a plurality of optical switches and a reflection layer, and the method includes: determining a reflection area and a non-reflection area of the mirror display device according to an acquired scene image; controlling an optical switch corresponding to the reflection area to be in a first state to obtain a first light beam based on incident light; controlling an optical switch corresponding to the non-reflection area to be in a second state different from the first state; and receiving and reflecting, by the reflection layer, the first light beam incident on the reflection layer.

According to a third aspect of the embodiments of the present disclosure, there is provided an electronic device, including: a processor; and a memory storing computer-readable instructions, which, when executed by the processor, implement the method for displaying the image in the second aspect.

According to a fourth aspect of the embodiments of the present disclosure, there is provided a computer-readable storage medium on which a computer program is stored, and the computer program, when executed by a processor, implements the method for displaying the image in the second aspect.

It should be noted that the above general description and the following detailed description are merely exemplary and explanatory and should not be construed as limiting of the disclosure.

### BRIEF DESCRIPTION OF THE DRAWINGS

The drawings, which are incorporated in and constitute a part of the specification, illustrate embodiments consistent with the present disclosure and, together with the specification, serve to explain principles of the present disclosure. It is apparent that the drawings in the following description are only some of the embodiments of the present disclosure, and other drawings may be obtained by those skilled in the art without creative work, in which:

FIG. 1 shows a schematic block diagram of a mirror display device according to an embodiment of the present disclosure;

FIG. 2 shows a schematic structural diagram of an optical switch array according to an embodiment of the present disclosure:

FIG. 3 shows a schematic structural diagram of pixel areas distributed in an array according to an embodiment of the present disclosure:

FIG. 4 shows a schematic structural diagram of a mirror display device according to an embodiment of the present disclosure;

FIG. 5 shows an exploded view of a three-dimensional structure of a mirror display device according to an embodiment of the present disclosure;

FIG. 6 shows a schematic structural diagram of another mirror display device according to an embodiment of the present disclosure;

FIG. 7 shows an exploded view of a three-dimensional structure of another mirror display device according to an embodiment of the present disclosure:

FIG. 8 shows a schematic diagram of a workflow of a mirror display device according to an embodiment of the present disclosure;

FIG. 9 shows a schematic diagram of a framework of still another mirror display device according to an embodiment of the present disclosure;

FIG. 10 shows a schematic flowchart of determining different areas by a control module according to an embodiment of the present disclosure;

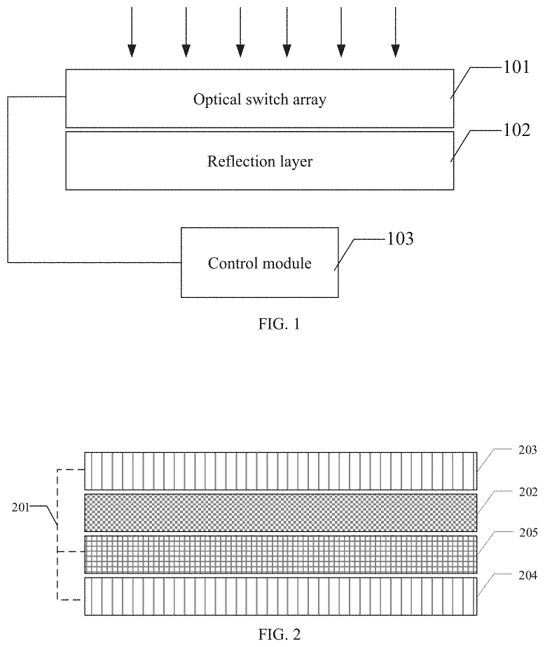

FIG. 1I shows a schematic diagram of a framework of a contour extraction unit according to an embodiment of the present disclosure;

FIG. 12 shows a schematic flowchart of extracting a contour of a target object by a contour extraction unit according to an embodiment of the present disclosure;

FIG. 13 shows a schematic diagram of a framework of still another mirror display device according to an embodiment of the present disclosure;

FIG. 14 shows a schematic diagram of extracting a foreground image through background subtraction according to an embodiment of the present disclosure:

FIG. 15 shows a schematic diagram of a framework of a contour extraction sub-unit according to an embodiment of the present disclosure;

FIG. 16 shows a schematic diagram of a framework of an area determination unit according to an embodiment of the present disclosure:

FIG. 17 shows a schematic flowchart of determining a reflection area and a non-reflection area by an area determination unit according to an embodiment of the present disclosure:

FIG. 18 shows a schematic diagram of obtaining a non-reflection area by performing semantic segmentation on a scene image based on a key point according to an embodiment of the present disclosure:

FIG. 19 shows a schematic diagram of a principle of a mirror display device in a first state according to an embodiment of the present disclosure;

FIG. 20 shows a schematic diagram of a principle of a mirror display device in a second state according to an embodiment of the present disclosure;

FIG. 21 shows a schematic diagram of a principle of another mirror display device in a first state according to an embodiment of the present disclosure;

FIG. 22 shows a schematic diagram of a principle of another mirror display device in a second state according to an embodiment of the present disclosure:

FIG. 23 shows a schematic flowchart of displaying a boundary between a reflection area and a non-reflection area in a transitional manner by a mirror display device according to an exemplary embodiment of the present disclosure:

FIG. 24 shows a schematic structural diagram of a computer system of an electronic device according to an embodiment of the present disclosure; and

FIG. 25 shows a schematic diagram of a computer-readable storage medium according to an embodiment of the present disclosure.

In the drawings, the same or corresponding reference signs denote the same or corresponding parts.

### DETAILED DESCRIPTION

Embodiments will now be described more fully with reference to the drawings. However, the embodiments can be implemented in a variety of forms and should not be construed as being limited to examples set forth herein; rather, these embodiments are provided so that the present disclosure will be more complete and full so as to convey the idea of the embodiments to those skilled in this art.

In addition, the described features, structures, or characteristics in one or more embodiments may be combined in any suitable manner. In the following description, many specific details are provided to give a full understanding of the embodiments of the present disclosure. However, those skilled in the art will appreciate that the technical solution of the present disclosure may be practiced without one or more of the specific details, or other methods, components, devices, steps and the like may be employed. In other instances, well-known methods, devices, implementations or operations are not shown or described in detail to avoid obscuring various aspects of the present disclosure.

In addition, the drawings are merely schematic representations and are not necessarily drawn to scale. The block diagrams shown in the drawings are only functional entities and do not necessarily correspond to physically separate entities. That is, these functional entities may be implemented in a form of software, or implemented in one or more hardware modules or integrated circuits, or implemented in different networks and/or processor devices and/or microcontroller devices.

It should be noted that, in the drawings, sizes of layers and areas may be exaggerated for clarity of illustration. In addition, it can be understood that when an element or layer is referred to as being “on” another element or layer, it can be directly on the other element, or an intervening layer may be present. In addition, it can be understood that w % ben an element or layer is referred to as being “under” another element or layer, it can be directly under the other element, or more than one intervening layer or element may be present. In addition, it can be understood that when a layer or element is referred to as being “between” two elements or layers, it can be the only layer between the two elements or layers, or more than one intervening layer or element may also be present. Throughout the description, similar reference signs refer to similar elements.

In the embodiments of the present disclosure, there is first provided a mirror display device. Referring to FIG. 1, the mirror display device in the embodiments of the present disclosure may include an optical switch array 101, a reflection layer 102 and a control module 103. The optical switch array 101 may include a plurality of optical switches that can be configured to obtain, in a first state, a first light beam based on incident light. The reflection layer 102 may be disposed on a side of the optical switch array 101 and configured to receive and reflect the first light beam incident on the reflection layer 102. The control module 103 can be configured to determine to display a reflection area and a non-reflection area on the mirror display device, and control an optical switch corresponding to the reflection area to be in the first state and an optical switch corresponding to the non-reflection area to be in a second state different from the first state.

In the mirror display device provided in the embodiments of the present disclosure, the optical switch array including the plurality of optical switches and the reflection layer capable of reflecting the first light beam are provided, and after the reflection area and the non-reflection area are determined, the optical switch corresponding to the reflection area can be controlled to be in the first state, so that the incident light forms the first light beam to be incident on the reflection layer, so as to achieve a mirror effect; at the same time, the optical switch corresponding to the non-reflection area can be controlled to be in the second state to prevent the incident light from forming the first light beam to be incident on the reflection layer, so as to achieve a non-mirror effect. On the one hand, a more realistic mirror image can be presented in the mirror display device by the reflection layer reflecting the first light beam incident on the reflection layer, thereby improving the mirror effect in the mirror display device; in addition, the mirror effect in the mirror display device can be realized only by the reflection layer reflecting the light beam, saving power resources. On the other hand, the reflection area and the non-reflection area are determined by the control module, and the optical switch array controls the light beam to display the reflection area and the non-reflection area on the mirror display device, thereby realizing the distinctive display of target objects in the displayed mirror image, and the non-reflection area can be dynamically changed according to a dynamic change of the target object, which is simple to realize and saves the production cost.

Hereinafter, the mirror display device in the embodiments of the present disclosure will be further described.

In an embodiment of the present disclosure, when the reflection area and the non-reflection area are displayed on the mirror display device, the optical switch corresponding to the reflection area can be controlled to be in the first state, so that the incident light forms the first light beam to be incident on the reflection layer, so as to achieve the mirror effect, and at the same time, the optical switch corresponding to the non-reflection area can be controlled to be in the second state to prevent the incident light from forming the first light beam to be incident on the reflection layer, so as to achieve the non-mirror effect.

Specifically, in order to prevent the incident light from forming the first light beam to be incident on the reflection layer, in one case, when the optical switch is in the second state, a second light beam can be obtained based on the incident light, and the second light beam incident on the reflection layer can be received and transmitted by the reflection layer. In another case, when the optical switch is in the second state, the incident light can be blocked from being incident on the reflection layer. In addition, based on the optical switch in the second state, it is also possible to prevent the incident light from forming the first light beam to be incident on the reflection layer in other manners, which is not specially limited by the embodiments of the present disclosure.

The following is a detailed description based on the two manners mentioned above. It is easy to understand that embodiments having the same principle or similar effect as these two manners to prevent the incident light from forming the first light beam to be incident on the reflection layer are also within a protection scope of the present disclosure.

In an embodiment of the present disclosure, the control module 103 controls the optical switch in the optical switch array 101 corresponding to the reflection area to be in the first state, so that the optical switch obtains the first light beam based on the incident light, and then the reflection layer 102 receives and reflects the first light beam incident on the reflection layer 102, so as to present the reflection area on the mirror display device. In order to present the non-reflection area on the mirror display device, the optical switch in the optical switch array 101 can also be configured to obtain the second light beam based on the incident light incident on the optical switch array 101 when the optical switch is in the second state. In this case, the reflection layer 102 can also be configured to receive and transmit the second light beam incident on the reflection layer 102.

In an embodiment of the present disclosure, the optical switch array 101 may include a plurality of optical switches distributed in an array, which may be liquid crystal switches or photorefractive switches, or other types of optical switches that can implement the first state or the second state such as microelectronic mechanical optical switches. Therefore, the optical switches are not limited to the implementations listed in the embodiment of the present disclosure.

The optical switch array including the liquid crystal switches is taken as an example for description below. Referring to FIG. 2, the optical switch array may include an array substrate 201 and a liquid crystal layer 202.

The array substrate 201 may include a plurality of pixel areas distributed in an array, and an electric field of each pixel area can be controlled by the control module 103; and

the liquid crystal layer 202 may be distributed in each pixel area, and liquid crystal in each pixel area can perform a first deflection according to the electric field to form an optical switch in the first state, and can perform a second deflection to form an optical switch in the second state.

Specifically, with continued reference to FIG. 2, the array substrate 201 may specifically include a first substrate 203, a second substrate 204 and an electrode layer 205. The second substrate 204 may be disposed opposite to the first substrate 203, and the liquid crystal layer 202 may be filled between the first substrate 203 and the second substrate 204. The electrode layer 205 can be electrically coupled with the control module 103, and the electrode layer in FIG. 2 is disposed on the second substrate 204. In addition, the electrode layer 205 can also be disposed on the first substrate 203, or can also be disposed on the first substrate 203 and the second substrate 204, which is not specially limited by the embodiments of the present disclosure.

In an embodiment of the present disclosure, individual pixel areas may be distributed on the electrode layer 205 in the array, and each pixel area may include a control switch. Taking the control switch as a thin film transistor as an example, the control switch may include a gate, a source and a drain, where the gate of the control switch can receive a control signal from the control module, the source of the control switch can receive a data signal, and the drain can be coupled with a pixel electrode. The first substrate 203 (the electrode layer 205 is disposed on the first substrate 203) can be formed with a common electrode. When the control signal is at a turning-on level, the control switch is turned on, and the data signal is input to the pixel electrode, thereby changing an electric field between the pixel electrode and the common electrode. In the embodiment of the present disclosure, the electric field between the pixel electrode and the common electrode is a longitudinal electric field. However, in other embodiments of the present disclosure, the common electrode may also be formed on the second substrate 204 (the electrode layer 205 is disposed on the second substrate 204), the electric field between the pixel electrode and the common electrode is a horizontal electric field or other electric fields such as a multi-dimensional electric field. Taking the multi-dimensional electric field as an example, the pixel electrode and the common electrode can both be comb-shaped electrodes, and are disposed on the first substrate and/or the second substrate at an interval, which is not specially limited by the embodiments of the present disclosure.

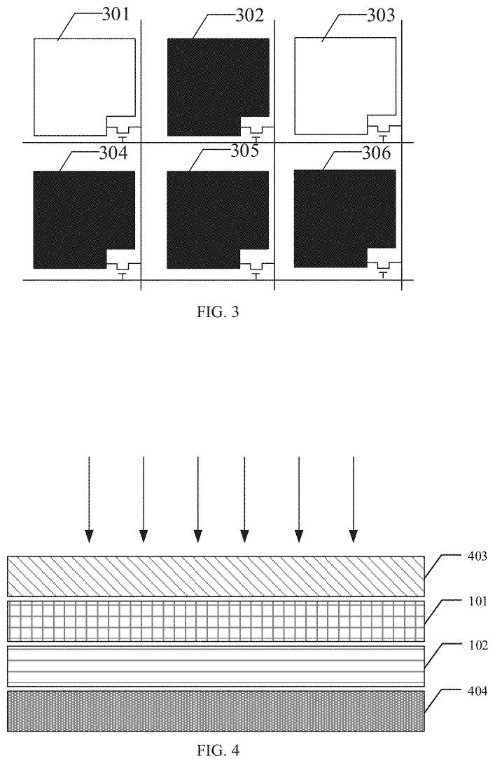

Referring to FIG. 3, it is assumed that the array substrate 201 includes a pixel area 301, a pixel area 302, a pixel area 303, a pixel area 304, a pixel area 305 and a pixel area 306 distributed in an array. In this case, if pixels on the mirror display device corresponding to the reflection area determined by the control module 103 are the pixel area 301 and the pixel area 303, and pixels on the mirror display device corresponding to the determined non-reflection area are the pixel area 302, the pixel area 304, the pixel area 305 and the pixel area 306, the control module 103 sends a first control signal to the pixel area 301 and the pixel area 303 to control the control switches of these pixel areas to be in the first state (i.e., the optical switches are in the first state), and the first light beam is obtained after the incident light passes through the liquid crystal corresponding to these pixel areas, so that the first light beam is incident on the reflection layer and reflected by the reflection layer.

At the same time, the control module 103 sends a second control signal to the pixel area 302, the pixel area 304, the pixel area 305 and the pixel area 306 to control the control switches of these pixel areas to be in the second state (i.e., the optical switches are in the second state). In this case, through the deflection of the liquid crystal corresponding to the pixel area 302, the pixel area 304, the pixel area 305 and the pixel area 306 due to a change of the electric field, the second light beam is obtained after the incident light passes through the liquid crystal corresponding to these pixel areas, so that the second light beam is incident on the reflection layer and transmitted by the reflection layer. Note that, this is only an exemplary illustration, and should not impose any limitation on the embodiments of the present disclosure.

In an embodiment of the present disclosure, the pixel area may not be provided with a color filter, or may not be provided with sub-pixels, and the control switch in the pixel area is only controlled by the control signal from the control module to realize the presentation of the mirror image on the mirror display device.

In an embodiment of the present disclosure, in order to ensure that the first light beam or the second light beam can be incident on the reflection layer 102 through the optical switch array 101, the first substrate 203 and the second substrate 204 in the optical switch array 101 may be transparent substrates, and a material used for the transparent substrate may be polymethyl methacrylate (PMMA), polycarbonate (PC), polyvinyl chloride (PVC) or other transparent materials, which is not specially limited by the embodiments of the present disclosure. For the same purpose, the electrode layer 205 can also be a transparent electrode layer, and a material of the transparent electrode layer can include, but is not limited to, an Indium Tin Oxide (ITO) semiconductor transparent conductive film or other transparent conductive materials, which is not specially limited by the embodiments of the present disclosure.

In an embodiment of the present disclosure, in order to enable the mirror display device to simultaneously display the reflection area and the non-reflection area, that is, enable the reflection layer 102 to both reflect the light beam and transmit the light beam, the reflection layer 102 may be a transflective layer, and the transflective layer can reflect the first light beam in a first polarization direction, and can also transmit the second light beam in a second polarization direction.

In an embodiment of the present disclosure, referring to FIG. 4, in order to better enable the optical switches in the optical switch array 101 to obtain the first light beam and the second light beam, the mirror display device may further include a polarizer 403.

The polarizer 403 can be disposed on an optical path along which the incident light is incident on the optical switch array 101 to obtain a polarized light beam. For example, the polarizer 403 can be disposed on the first substrate 203 or under the first substrate 203 (that is, between the first substrate 203 and the liquid crystal layer 202), which is not specially limited by the embodiments of the present disclosure. When the polarized light beam passes through liquid crystal in a first deflection state in the liquid crystal layer 202 (that is, the optical switch is in the first state), the first light beam in the first polarization direction can be obtained, and when the polarized light beam passes through liquid crystal in a second deflection state in the liquid crystal layer 202 (that is, the optical switch is in the second state), the second light beam in the second polarization direction can be obtained.

In an embodiment of the present disclosure, with continued reference to FIG. 4, in order to avoid the diffuse reflection of the second light beam transmitted through the incident layer in the non-reflection area of the mirror display device, and also in order to enable to present the non-reflection area in a better effect, a light absorption layer 404 can be disposed under the reflection layer 102, that is, the light absorption layer 404 is disposed on an optical path of the second light beam transmitted through the reflection layer 102, and can be used to absorb the second light beam transmitted through the reflection layer 102.

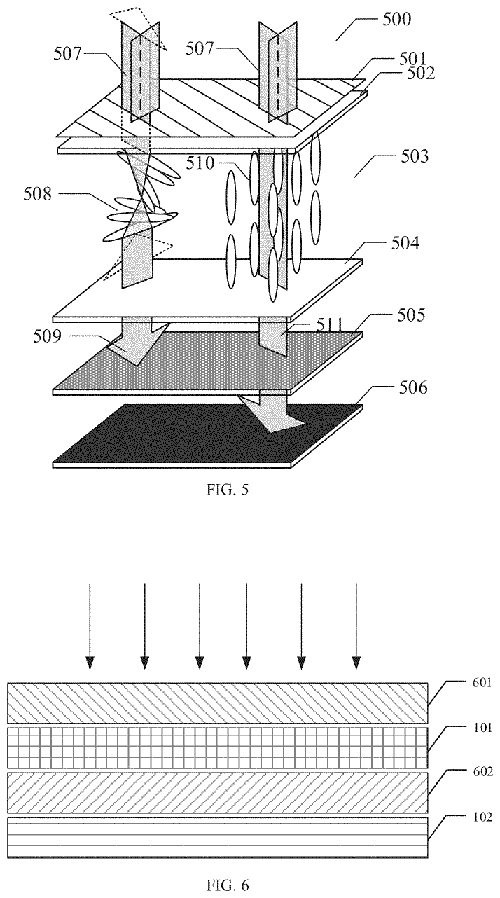

Referring to FIG. 5, a mirror display device 500 includes a polarizer 501, a first substrate 502, a liquid crystal layer 503, a second substrate 504, a reflection layer 505 and a light absorption layer 506.

When incident light 507 is incident on the mirror display device 500, the polarized light beam is first obtained based on the incident light 507 through the polarizer 501, and the polarized light beam passes through the first substrate 502, and is incident on an optical switch 508 in the first state. When the polarized light beam passes through the optical switch 508 in the first state, a first light beam 509 in the first polarization direction is obtained, and the first light beam 509 is incident on the reflection layer 505 after passing through the second substrate 504. At this point, the reflection layer 505 reflects the first light beam 509 in the first polarization direction and makes the first light beam 509 return according to an incident optical path to form the reflection area on the mirror display device 500.

Meanwhile, when the incident light 507 is incident on the mirror display device 500, the polarized light beam is first obtained based on the incident light 507 through the polarizer 501, and the polarized light beam passes through the first substrate 502, and is incident on an optical switch 510 in the second state. When the polarized light beam passes through the optical switch 510 in the second state, a second light beam 511 in the second polarization direction is obtained, and the second light beam 511 is incident on the reflection layer 505 after passing through the second substrate 504. At this point, the reflection layer 505 transmits the second light beam 511 in the second polarization direction and makes the second light beam 511 continue to be incident on the light absorption layer 506. At this point, the light absorption layer 506 absorbs the incident second light beam 511 to form the non-reflection area on the mirror display device 500.

Note that, the structure in FIG. 5 is only an exemplary illustration, and the mirror display device 500 may also include other structures having the same principle or capable of realizing the same function, and the description here should not impose any special limitation on the embodiments of the present disclosure.

In another embodiment of the present disclosure, in order to present the non-reflection area on the mirror display device, in addition to making the optical switch in the optical switch array 101 corresponding to the non-reflection area in the second state to obtain the second light beam, and receiving and transmitting, by the reflection layer 102, the second light beam incident on the reflection layer 102, the incident light can also be blocked from being incident on the reflection layer when the optical switch in the optical switch array 101 corresponding to the non-reflection area is in the second state, which can also realize the presentation of the non-reflection area on the mirror display device.

In another embodiment of the present disclosure, referring to FIG. 6, in order to block the incident light from being incident on the reflection layer when the optical switch corresponding to the non-reflection area is in the second state, the structure of the mirror display device may further include a first polarizer 601 and a second polarizer 602.

The first polarizer 601 can be disposed on the optical path along which the incident light is incident on the optical switch array 101, and can be configured to obtain the polarized light beam. For example, the first polarizer 601 can be disposed on the optical switch array 101. When the polarized light beam passes through the liquid crystal in the first deflection state, the first light beam in the first polarization direction is obtained, and when the polarized light beam passes through the liquid crystal in the second deflection state, the second light beam in the second polarization direction is obtained.

The second polarizer 602 can be disposed on an optical path along which the first light beam is incident on the reflection layer, and the polarization direction of the second polarizer is the first polarization direction, and the light beam in the second polarization direction can be blocked from being incident on the reflection layer by the second polarizer in the first polarization direction.

In another embodiment of the present disclosure, the optical switch array 101 may include the plurality of optical switches distributed in an array, and the optical switches may be the liquid crystal switches or the photorefractive switches, or other types of optical switches that can implement the first state or the second state such as the microelectronic mechanical optical switches. Therefore, the optical switches are not limited to the implementations listed in the embodiment of the present disclosure.

In another embodiment of the present disclosure, for the specific structure and function of the optical switch array 101, reference may be made to the structure in FIG. 2 and the corresponding explanation in the above embodiments, which will not be repeated here.

In another embodiment of the present disclosure, for the reflection layer 102, reference may be made to the explanation of the reflection layer in the above embodiments, which will not be repeated here.

In another embodiment of the present disclosure, with continued reference to FIG. 3, it is assumed that the array substrate 201 includes the pixel area 301, the pixel area 302, the pixel area 303, the pixel area 304, the pixel area 305 and the pixel area 306 distributed in an array. In this case, if the pixels on the mirror display device corresponding to the reflection area determined by the control module 103 are the pixel area 301 and the pixel area 303, and the pixels on the mirror display device corresponding to the determined non-reflection area are the pixel area 302, the pixel area 304, the pixel area 305 and the pixel area 306, the control module 103 sends the first control signal to the pixel area 301 and the pixel area 303 to control the control switches of these pixel areas to be in the first state (i.e., the optical switches are in the first state). The first polarizer 601 obtains the polarized light beam based on the incident light, and the first light beam in the first polarization direction is obtained after the polarized light beam passes through the liquid crystal corresponding to these pixel areas, so that after passing through the second polarizer that is in the first polarization direction, the first light beam is incident on the reflection layer and reflected by the reflection layer.

At the same time, the control module 103 sends the second control signal to the pixel area 302, the pixel area 304, the pixel area 305 and the pixel area 306 to control the control switches of these pixel areas to be in the second state (i.e., the optical switches are in the second state). In this case, through the deflection of the liquid crystal corresponding to the pixel area 302, the pixel area 304, the pixel area 305 and the pixel area 306 due to a change of the electric field, the first polarizer 601 obtains the polarized light beam based on the incident light. The second light beam in the second polarization direction is obtained after the polarized light beam passes through the liquid crystal corresponding to these pixel areas. When the second light beam is incident on the second polarizer 602 that is in the first polarization direction, the second light beam in the second polarization direction is blocked by the second polarizer 602 in the first polarization direction due to the different polarization directions, which avoids the second light beam being incident on the reflection layer.

In another embodiment of the present disclosure, the pixel area may not be provided with the color filter, or may not be provided with the sub-pixels, and the control switch in the pixel area is only controlled by the control signal from the control module to realize the presentation of the mirror image on the mirror display device.

In another embodiment of the present disclosure, in order to ensure that the first light beam can be incident on the reflection layer 102 through the optical switch array 101, the first substrate 203 and the second substrate 204 in the optical switch array 101 may be the transparent substrates, and the material used for the transparent substrate may be polymethyl methacrylate (PMMA), polycarbonate (PC), polyvinyl chloride (PVC) or other transparent materials, which is not specially limited by the embodiments of the present disclosure. For the same purpose, the electrode layer 205 can also be the transparent electrode layer, and the material of the transparent electrode layer can include, but is not limited to, an Indium Tin Oxide (ITO) semiconductor transparent conductive film or other transparent conductive materials, which is not specially limited by the embodiments of the present disclosure.

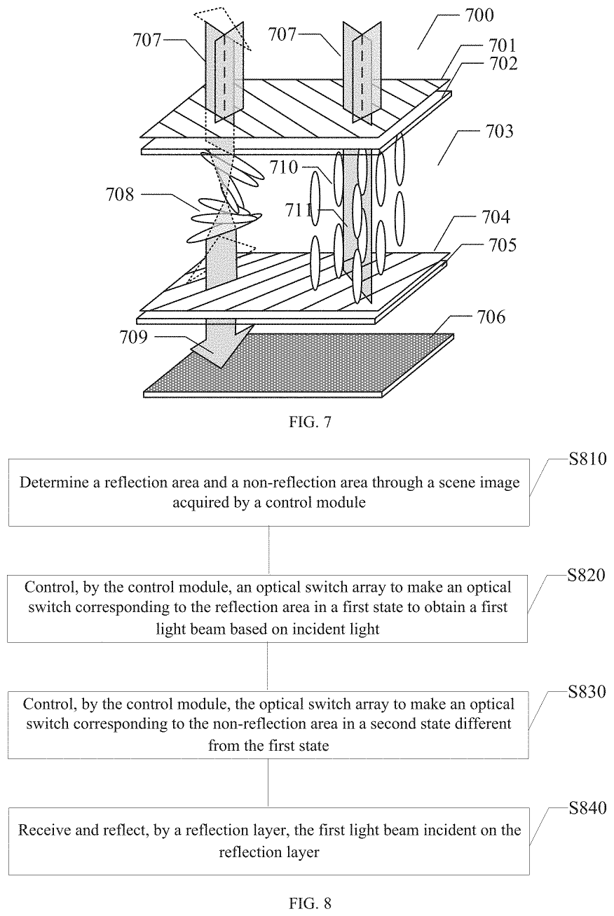

Referring to FIG. 7, a mirror display device 700 includes a first polarizer 701, a first substrate 702, a liquid crystal layer 703, a second polarizer 704, a second substrate 705, and a reflection layer 706.

When incident light 707 is incident on the mirror display device 700, the polarized light beam is first obtained based on the incident light 707 through the first polarizer 701, and the polarized light beam passes through the first substrate 702, and is incident on an optical switch 708 in the first state. When the polarized light beam passes through the optical switch 708 in the first state, a first light beam 709 in the first polarization direction is obtained, and the first light beam 709 is incident on the reflection layer 706 after passing through the second substrate 705. At this point, the reflection layer 706 reflects the first light beam 709 and makes the first light beam 709 return according to the incident optical path to form the reflection area on the mirror display device 700.

Meanwhile, when the incident light 707 is incident on the mirror display device 700, the polarized light beam is first obtained based on the incident light 707 through the first polarizer 701, and the polarized light beam passes through the first substrate 702, and is incident on an optical switch 710 in the second state. When the polarized light beam passes through the optical switch 710 in the second state, a second light beam 711 in the second polarization direction is obtained. When the second light beam 711 passes through the second polarizer 704 that is in the first polarization direction, the second light beam 711 is blocked by the second polarizer 704 in the first polarization direction due to the different polarization directions, and cannot be incident on the reflection layer 706, so as to form the non-reflection area on the mirror display device 700.

Note that, the structure in FIG. 7 is only an exemplary illustration, and the mirror display device 700 may also include other structures having the same principle or capable of realizing the same function, and the description here should not impose any special limitation on the embodiments of the present disclosure.

In the above-mentioned embodiments of the present disclosure, with continued reference to FIG. 1, the mirror display device may include the optical switch array 101, the reflection layer 102 and the control module 103. The optical switch array 101 may include the plurality of optical switches which can be configured to obtain, in the first state, the first light beam based on the incident light. The reflection layer 102 may be disposed on the side of the optical switch array 101 and configured to receive and reflect the first light beam incident on the reflection layer 102. The control module 103 can be configured to determine to display the reflection area and the non-reflection area on the mirror display device, and control the optical switch corresponding to the reflection area to be in the first state and the optical switch corresponding to the non-reflection area to be in the second state different from the first state.

The optical switch array 101, the reflection layer 102 and the control module 103 will be further described below in conjunction with a workflow of the mirror display device.

Referring to FIG. 8, the workflow of the mirror display device may include steps S810 to S840.

In the step S810, the reflection area and the non-reflection area are determined through a scene image acquired by the control module 103.

In an embodiment of the present disclosure, the scene image may refer to an image that is acquired by the control module 103 and corresponds to a certain area in a current scene. In addition, the scene image may specifically refer to a plurality of frame images in an acquired scene video of the current scene. A dynamically changing non-reflection area is realized by processing each frame of the scene image on the current timeline.

In the step S820, the optical switch array 101 is controlled by the control module 103 to make the optical switch corresponding to the reflection area in the first state, so as to obtain the first light beam based on the incident light.

In an embodiment of the present disclosure, the control module 103 may determine a first pixel area coordinate corresponding to the reflection area and a second pixel area coordinate corresponding to the non-reflection area, and generate the first control signal based on the first pixel area coordinate and the second control signal based on the second pixel area coordinate. The control module 103 sends the first control signal to the optical switch array 101 to control the optical switch corresponding to the reflection area to be in the first state. Through the optical switch in the first state, the first light beam is obtained based on the incident light, for example, through the liquid crystal switch in the first state, the first light beam in the first polarization direction is obtained based on the incident light.

In the step S830, the optical switch array 101 is controlled by the control module 103 to make the optical switch corresponding to the non-reflection area in the second state different from the first state.

In an embodiment of the present disclosure, the second control signal can be obtained based on the control module 103, and sent to the optical switch array 101 by the control module 103 to control the optical switch corresponding to the non-reflection area to be in the second state. Through the optical switch in the second state, the second light beam is obtained based on the incident light, for example, through the liquid crystal switch in the second state, the second light beam in the second polarization direction is obtained based on the incident light.

In the step S840, the first light beam incident on the reflection layer 102 is received and reflected by the reflection layer 102.

In an embodiment of the present disclosure, the first light beam incident on the reflection layer 102 may be received and reflected by the reflection layer 102 to display the corresponding reflection area on the mirror display device. Meanwhile, through the optical switch in the second state, the incident light can be prevented from forming the first light beam, so as to display the corresponding non-reflection area on the mirror display device. For example, the second light beam incident on the reflection layer 102 can be received and transmitted through the reflection layer 102, so as to display the corresponding non-reflection area on the mirror display device. Alternatively, through the optical switch in the second state, the incident light can also be blocked from being incident on the reflection layer 102. Note that, other manners in which through the optical switch in the second state, the incident light can be prevented from forming the first light beam are also possible, which is not specially limited by the embodiments of the present disclosure.

In an embodiment of the present disclosure, referring to FIG. 9, a mirror display device 900 may include the optical switch array 101, the reflection layer 102 and the control module 103. The control module 103 may specifically include an image acquisition unit 901, a contour extraction unit 902 and an area determination unit 903.

The image acquisition unit 901 can be configured to acquire the scene image corresponding to the current scene; the contour extraction unit 902 can be coupled with the image acquisition unit 901, and can be configured to extract a contour of a target object from the acquired scene image; and the area determination unit 903 can be coupled with the contour extraction unit 902, and can be configured to determine the reflection area and the non-reflection area according to the contour of the target object extracted by the contour extraction unit 902.

The image acquisition unit 901, the contour extraction unit 902, and the area determination unit 903 described above will be further described below in conjunction with the workflow of the mirror display device.

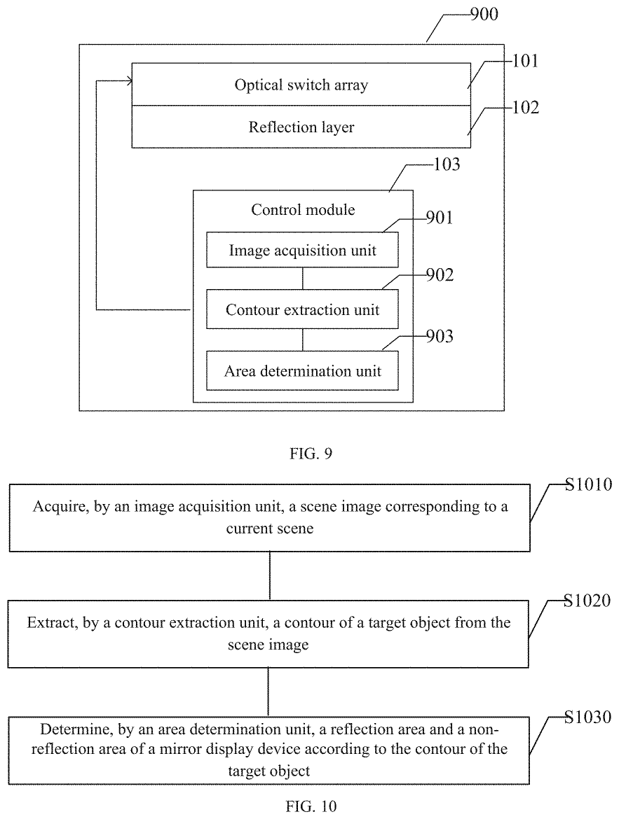

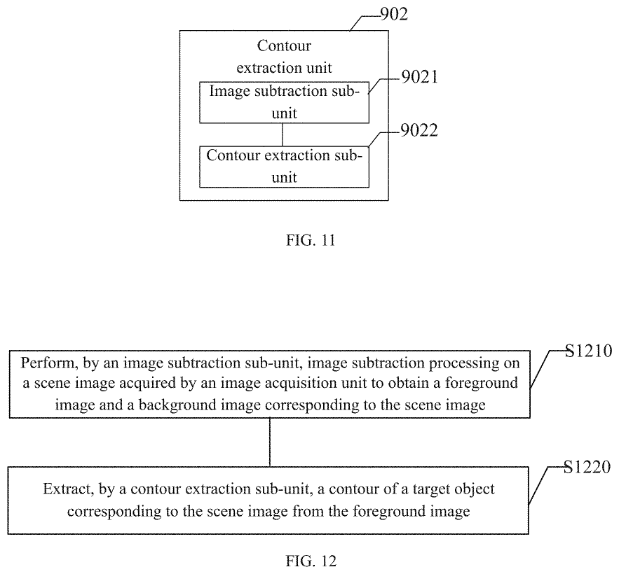

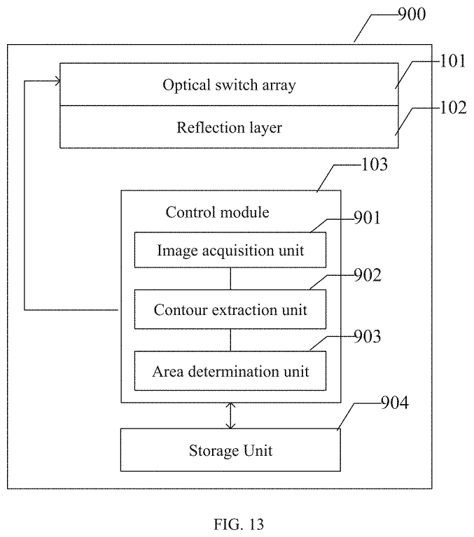

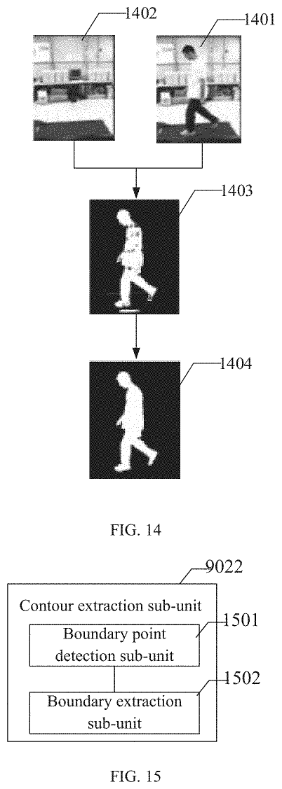

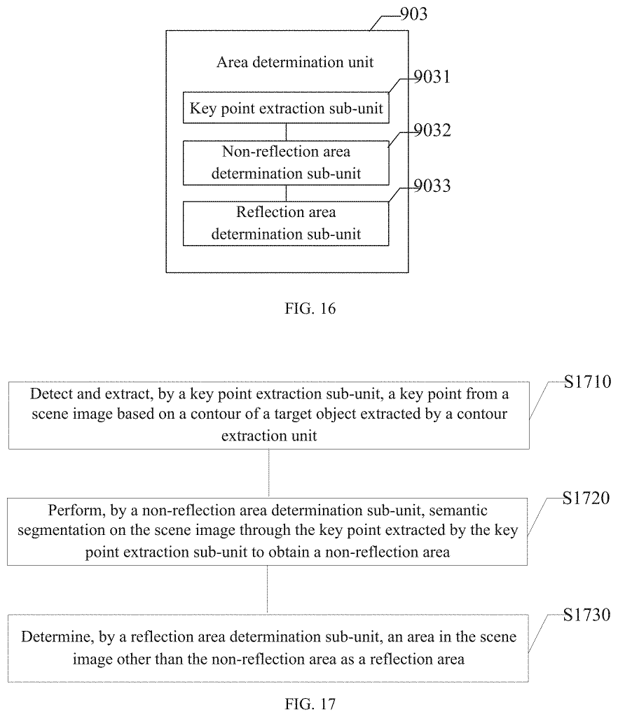

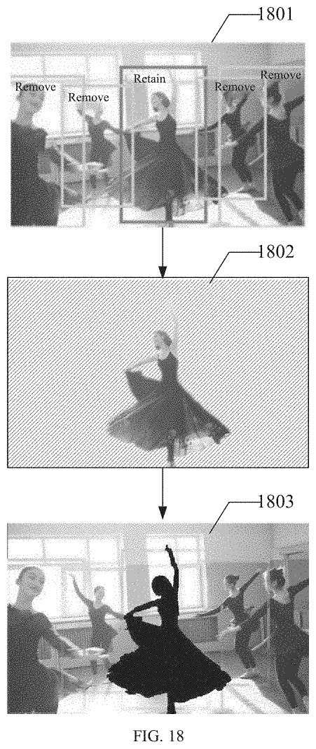

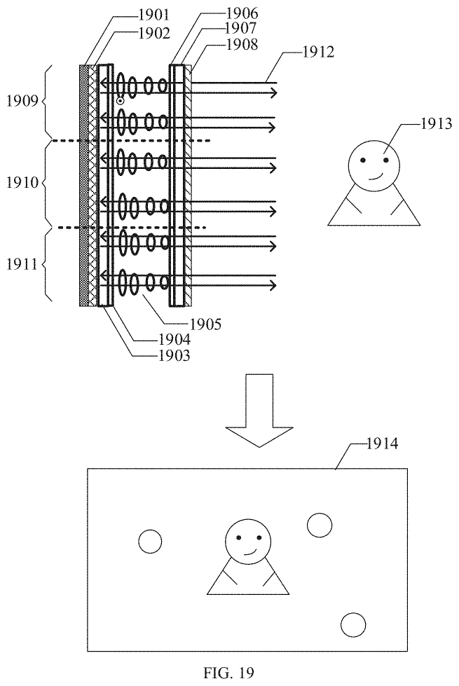

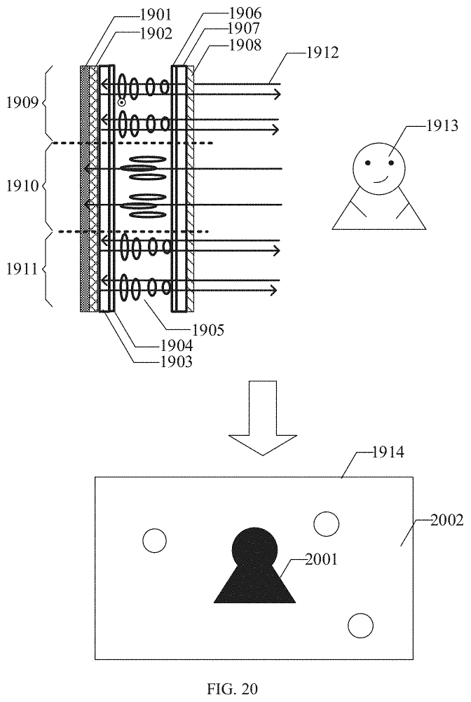

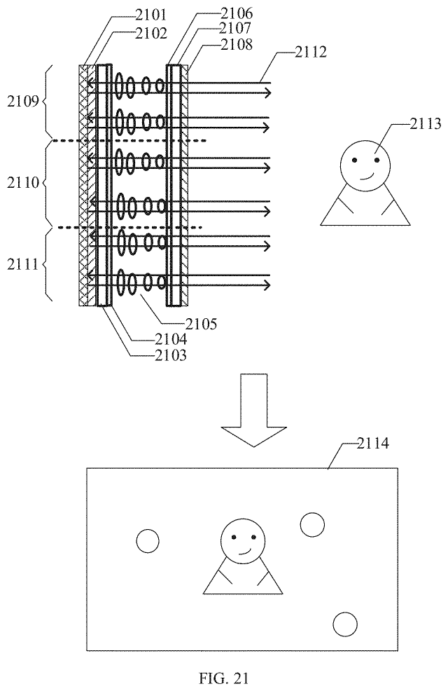

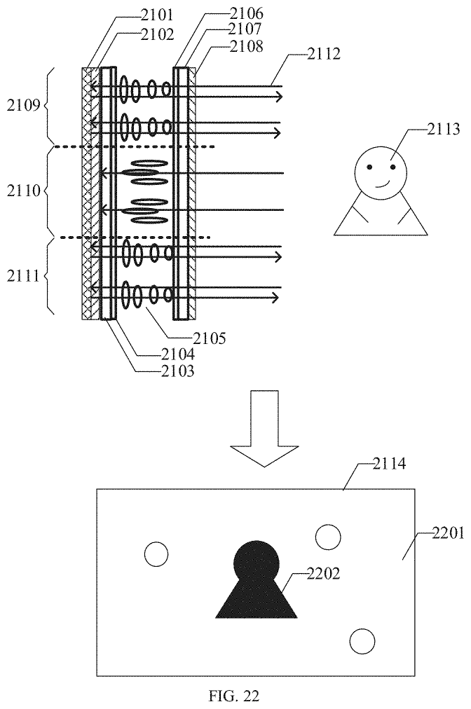

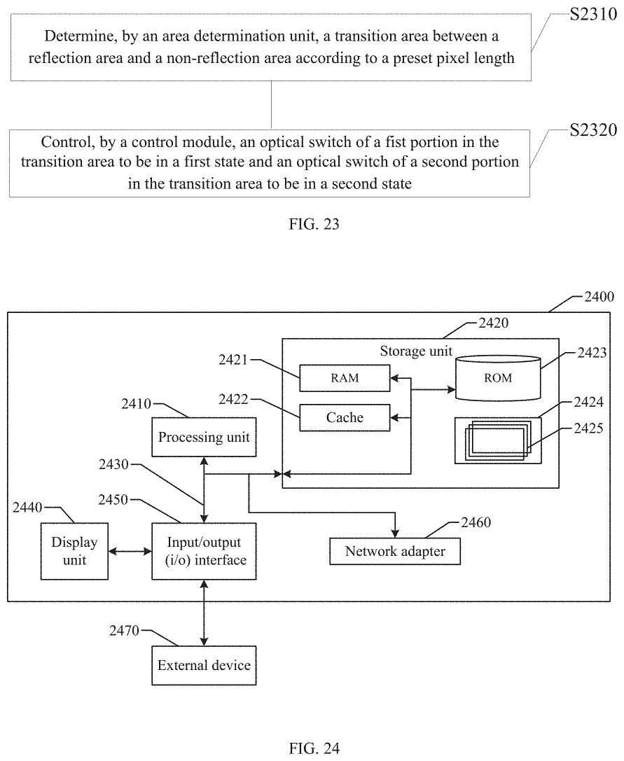

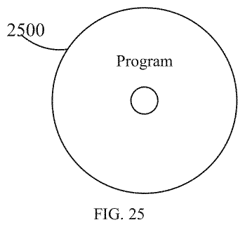

Referring to FIG. 10, the workflow of the mirror display device may include:

in step S1010, the scene image corresponding to the current scene is acquired by the image acquisition unit 901;

in step S1020, the contour of the target object is extracted from the scene image by the contour extraction unit 902; and

in step S1030, the reflection area and the non-reflection area of the mirror display device are determined by the area determination unit 903 according to the contour of the target object.

The current scene may refer to an environmental scene that a forward direction of the mirror display device faces and can be acquired by the image acquisition unit 901. The target object can refer to an object specified in the scene image, for example, the target object can be a moving person in the scene image, or a moving object (such as a passing vehicle, etc.) in the scene image, and it can also be a static item in the scene image, which is not specially limited by the embodiments of the present disclosure. By extracting the contour of the target object from the scene image and determining the reflection area and the non-reflection area of the mirror display device, the target object can be distinctively displayed on the mirror display device.

Specifically, referring to FIG. 11, the contour extraction unit 902 may specifically include an image subtraction sub-unit 9021 and a contour extraction sub-unit 9022. The image subtraction sub-unit 9021 can be configured to perform image subtraction processing on the scene image and determine a foreground image and a background image corresponding to the scene image; and the contour extraction sub-unit 9022 can be coupled with the image subtraction sub-unit 9021, and can be configured to extract the contour of the target object corresponding to the scene image from the foreground image.

The image subtraction sub-unit 9021 and the contour extraction sub-unit 9022 will be further described below in conjunction with the workflow of the mirror display device.

Referring to FIG. 12, the workflow of the mirror display device may include:

in step S1210, the image subtraction processing is performed, by the image subtraction sub-unit, on the scene image acquired by the image acquisition unit to obtain the foreground image and the background image corresponding to the scene image; and

in step S1220, the contour of the target object corresponding to the scene image is extracted from the foreground image by the contour extraction sub-unit.

The image subtraction processing may refer to a processing process in which the (dynamic) target object in the scene image (video sequence) is detected through a Background Subtraction and then Binarization Segmentation is performed on the target object and the background. By performing the image subtraction processing on the scene image, the foreground image containing the target object and the background image can be obtained. In addition, a processing process in which the foreground image containing the target object and the background image are segmented from the scene image through an image edge detection algorithm is also possible, which is not specially limited by the embodiments of the present disclosure.

The foreground image and the background image corresponding to the scene image are determined through the image subtraction processing, and the contour of the target object corresponding to the scene image is extracted based on the obtained foreground image, which can improve the accuracy of the obtained contour, so as to improve the precision of the non-reflection area corresponding to the target object.

In an embodiment of the present disclosure, with continued reference to FIG. 13, the mirror display device 900 may further include a storage unit 904, and the storage unit 904 may be configured to store a preset background model, and the background model may include a preset image that corresponds to the current scene and does not contain the target object. The background model may refer to a plurality of preset images that are acquired in advance, correspond to different times and spaces in the current scene and do not contain the target object. By setting the background model, the accuracy of performing the image subtraction processing on the scene image can be improved, so as to improve the precision of the non-reflection area corresponding to the target object.

Furthermore, the image subtraction sub-unit 9021 may be specifically configured to perform background subtraction processing on the preset image stored in the storage unit 904 and the scene image to obtain the foreground image and the background image corresponding to the scene image.

The background subtraction processing may refer to a process of processing the scene image and the preset image through the Background Subtraction. The Background Subtraction is the most commonly used method in motion detection. The subtraction between the current image and the background image can be used to detect a motion area. Specifically, a subtraction operation (or differential operation) can be performed on the preset image stored in the storage unit 904 and the scene image, a preset subtraction threshold (or differential threshold) is acquired, and binarization processing is performed on the subtraction image through the subtraction threshold to obtain the foreground image and the background image corresponding to the scene image. The Background Subtraction can generally provide the most complete feature data, but it is more sensitive to a change in a dynamic scene, such as illumination, and interference factors of external unrelated events. Therefore, by setting the background model corresponding to different times and spaces in the current scene and not containing the target object, the accuracy of the foreground image and the background image obtained by segmentation can be effectively improved, and the error due to different times or spaces of the current scene is reduced.

Note that, the corresponding foreground image and background image can also be obtained from the scene image through the image edge detection algorithm, and the foreground image and the background image corresponding to the scene image can also be obtained by other method that can detect the boundary and extract the target image, which is not specially limited by the embodiments of the present disclosure.

Referring to FIG. 14, the Background Subtraction is taken as an example for specific description. The image subtraction sub-unit 9021 in the control module 103 acquires, based on a scene image 1401 acquired by the image acquisition unit 901, a preset image 1402 corresponding to the time or space in the scene image from the background model stored in the storage unit 904, and then the image subtraction sub-unit 9021 performs the subtraction operation on the scene image 1401 and the preset image 1402 to obtain a subtraction image 1403 (including the foreground image corresponding to a light-colored area and the background image corresponding to a dark area) corresponding to the scene image 1401. Then, the preset subtraction threshold is acquired, and the binarization processing is performed on the subtraction image 1403 according to the subtraction threshold to obtain a resulting image 1404 corresponding to the scene image 1401. The resulting image 1404 includes the foreground image (a white area) and the background image (a black area). It should be understood, this is only an exemplary illustration, and should not impose any limitation on the embodiments of the present disclosure.

In an embodiment of the present disclosure, the contour of the target object in the foreground image can be extracted through a connectivity-based boundary tracking algorithm, which can be specifically implemented by a boundary point detection sub-unit 1501 and a boundary extraction sub-unit 1502 in the contour extraction sub-unit 9022, as shown in FIG. 15.

The boundary point detection sub-unit 1501 is configured to detect boundary points in the foreground image; and

the boundary extraction sub-unit 1502 is coupled with the boundary point detection sub-unit 1501, and can be configured to extract the contour of the target object corresponding to the scene image according to connected boundary points.

Based on the foreground image obtained by the image subtraction sub-unit 9021, the boundary point detection sub-unit 1501 scans the foreground image in an order from left to right and from top to bottom, first determines a boundary point at the top left of the target object (that is, a pixel point of the boundary), and then detects the next boundary point by taking the boundary point as a center and with a target size realm (for example, it can be a 3*3 realm) and a target direction (for example, the detection is performed in a direction downwards the boundary point), until multiple boundary points corresponding to the image boundary are found. Then, the boundary extraction sub-unit 1502 extracts the contour of the corresponding target object from the scene image according to the connected boundary points. By extracting the contour of the target object in the foreground image through the connectivity-based boundary tracking algorithm, the continuity and smoothness of the extracted contour of the target object can be ensured, the accuracy of the obtained contour can be further ensured, thereby improving the precision of the reflection area and the non-reflection area.

In other embodiments of the present disclosure, the contour extraction sub-unit 9022 can also extract the contour of the target object corresponding to the scene image through a Canny edge detection algorithm. For example, Gaussian blurring processing can be first performed on the obtained foreground image, and then an image gradient corresponding to the foreground image can be calculated, and an image edge amplitude and angle corresponding to the foreground image can be calculated based on the image gradient. Non-maximum signal suppression processing (i.e., image edge refining) is performed on the image edge amplitude and angle, then double-threshold edge connection processing is performed on the edge-refined foreground image, and the binarization is performed on the processed foreground image. Thereafter, the contour of the target object is extracted from the binarized foreground image. Please note that, the contour of the target object can also be extracted by other methods that can detect the boundary in the image, and the method for extracting the contour of the target object is not specially limited by the embodiments of the present disclosure.

In an embodiment of the present disclosure, the reflection area and the non-reflection area corresponding to the mirror display device may be determined based on the extracted contour of the target object and a key point detection algorithm, which can be specifically implemented by a key point extraction sub-unit 9031, a non-reflection area determination sub-unit 9032 and a reflection area determination sub-unit 9033 in the area determination unit 903, as shown in FIG. 16.

The key point extraction sub-unit 9031 can be configured to detect and extract a key point from the scene image according to the contour of the target object; the non-reflection area determination sub-unit 9032 is coupled with the key point extraction sub-unit 9031, and can be configured to perform semantic segmentation on the scene image according to the extracted key point to obtain the non-reflection area; and the reflection area determination sub-unit 9033 is coupled with the non-reflection area determination sub-unit 9032, and can be configured to determine an area in the scene image other than the non-reflection area as the reflection area.

The key point extraction sub-unit 9031, the non-reflection area determination sub-unit 9032, and the reflection area determination sub-unit 9033 will be further described below in conjunction with the work flow of the mirror display device.

Referring to FIG. 17, the workflow of the mirror display device may include:

in step S1710, the key point is detected and extracted from the scene image by the key point extraction sub-unit 9031 based on the contour of the target object extracted by the contour extraction unit 902;

in step S1720, the semantic segmentation is performed on the scene image by the non-reflection area determination sub-unit 9032 through the key point extracted by the key point extraction sub-unit 9031 to obtain the non-reflection area; and

in step S1730, the area in the scene image other than the non-reflection area is determined as the reflection area by the reflection area determination sub-unit 9033.

The key point may refer to a pixel point determined from the scene image and used to detect a motion state of the target object. The motion detection can be accurately and quickly performed on the target object through the key point detection. The semantic segmentation can refer to an image processing process of segmenting different image areas from the scene image based on a classification to which the pixel belongs. For example, pixels in an enclosed area corresponding to the contour of the target object can be regarded as the same classification, and pixels outside the enclosed area corresponding to the contour of the object can be regarded as another classification to obtain an area surrounded by the contour of the target object as the non-reflection area.

In addition, the non-reflection area can also be obtained by a sliding window detector-based target detection algorithm: windows with different sizes and proportions (aspect ratios) are used to slide on the scene image with a certain step, and image classification is performed on an area corresponding to a window, and then the non-reflection area is determined from the classified image area. Note that, there may also be other methods capable of determining the non-reflection area from the scene image, for example, the non-reflection area is determined through a texture detection-based target detection algorithm, which is not specially limited by the embodiments of the present disclosure.

After the non-reflection area corresponding to the mirror display device is obtained by segmenting the scene image through the contour of the target object, the area on the mirror display device other than the non-reflection area is an area that needs to present the mirror effect. Therefore, the area on the mirror display device other than the non-reflection area can be determined as the reflection area by the reflection area determination sub-unit 9033.

For example, it is assumed that the scene image contains a dynamic target portrait, after the above-mentioned image processing is performed on the scene image by the control module, a contour of the target portrait is extracted from the scene image, and an area corresponding to the target portrait is determined through the contour of the target portrait m conjunction with the key point detection. The area corresponding to the target portrait is regarded as the non-reflection area, and a background area other than the area corresponding to the target portrait is regarded as the reflection area. Then the control module generates corresponding electrical signals based on the determined non-reflection area and reflection area, and can control the optical switch corresponding to the reflection area in the mirror display device to be in the first state and the optical switch corresponding to the non-reflection area in the mirror display device to be in the second state through the electrical signals, so as to achieve the reflection area and the non-reflection area in the mirror display device.

Referring to FIG. 18, the key point can be detected and extracted from a scene image 1801 by the key point extraction sub-unit 9031 based on the contour of the target object extracted by the contour extraction unit 902, and the semantic segmentation is performed on the scene image 1801 to obtain the non-reflection area (a target portrait area) 1802 by the non-reflection area determination sub-unit 9032 through the key point extracted by the key point extraction sub-unit 9031. The mirror display device uses other areas in the scene image 1801 other than the non-reflection area (the target portrait area) 1802 as the reflection area by means of the control module 103, and sets the optical switch corresponding to the reflection area (a scene background area) to be in the first state (the optical switch in the first state obtains the first light beam based on the incident light) by means of the control module 103. At the same time, the mirror display device sets the optical switch corresponding to the non-reflection area (the target portrait area) 1802 to be in the second state by means of the control module 103 (the optical switch in the second state can obtain the second light beam based on the incident light or prevent the incident light from forming the first light beam to be incident on the reflection layer 102). In this case, the non-reflection area (the target portrait area) 1802 is displayed in a non-reflection state (for example, the second light beam transmitted through the reflection layer 102 can be absorbed by the light absorption layer 404, and the non-reflection area 1802 appears as the black area at this time; the second light beam can also be blocked from being incident on the reflection layer 102 by the second polarizer 602, and the non-reflection area 1802 presents an area in a preset state at this time; the non-reflection state is not specially limited in the embodiments of the present disclosure), and the reflection area is displayed as a mirror image (the reflection layer 102 reflects the first light beam incident on the reflection layer 102 to form the mirror image). Finally, a mirror image 1803 containing the non-reflection area (the target portrait area) 1802 is displayed on the mirror display device. Note that, this is only an exemplary illustration, and should not impose any limitation on the embodiments of the present disclosure.

In a case where when the optical switch is in the second state, the second light beam is obtained based on the incident light, and the second light beam incident on the reflection layer is received and transmitted by the reflection layer, implementation principles of the mirror display device in power-on and power-off states are respectively described below in combination with a specific application scenario.

Referring to FIG. 19, a structure of the mirror display device (from left to right of the figure) may include a light absorption layer 1901, a reflection layer 1902, a first substrate 1903, a first electrode layer 1904, a liquid crystal layer 1905, a second electrode layer 1906, a second substrate 1907 and a polarizer 1908, and may further include a pixel area 1909, a pixel area 1910 and a pixel area 1911 distributed in an array and formed by the optical switch array.

In an application scenario, if the mirror display device is in the power-off state, the control module and the optical switch array in the mirror display device do not work, and in this case, optical switches corresponding to the pixel area 1909, the pixel area 1910, and the pixel area 1911 are in the first state. The optical switch in the first state obtains the first light beam based on the incident light 1912, the first light beam is incident on the reflection layer 1902 after passing through the optical switch array, and the reflection layer 1902 can reflect the first light beam. At this time, a target object 1913 in the current scene can view a mirror image 1914 on the mirror display device.

In another application scenario, if the mirror display device is in the power-on state, both the control module and the optical switch array in the mirror display device can normally work. The control module acquires the scene image containing the target object 1913 in the current scene, and the control module determines that the target object 1913 is not a preset object (for example, the preset object can be a vehicle, etc.) by determining the extracted contour of the target object. In this case, the control module can use the entire scene image including the target object 1913 as the reflection area, and control the optical switches corresponding to the pixel area 1909, the pixel area 1910 and the pixel area 1911 to be in the first state through the electrical signal. The optical switch in the first state obtains the first light beam based on the incident light 1912, the first light beam is incident on the reflection layer 1902 after passing through the optical switch array, and the reflection layer 1902 can reflect the first light beam. At this time, the target object 1913 in the current scene can also view the mirror image 1914 on the mirror display device. Note that, this is only an exemplary illustration, and should not impose any limitation on the embodiments of the present disclosure.

Referring to FIG. 20, for the description of the structure of the mirror display device, reference may be specifically made to the description in FIG. 19, which will not be repeated here.

In an application scenario, if the mirror display device is in the power-on state, both the control module and the optical switch array in the mirror display device can normally work. The control module acquires the scene image containing the target object 1913 in the current scene, and the control module determines that the target object 1913 is the preset object (for example, the preset object can be a target portrait, etc.) by determining the extracted contour of the target object. In this case, the control module can segment the non-reflection area from the scene image containing the target object 1913 based on the contour of the target object, and use the area in the scene image other than the non-reflection area as the reflection area. The optical switches corresponding to the pixel area 1909 and the pixel area 1911 (assuming that the reflection area corresponds to the pixel area 1909 and the pixel area 1911) are controlled to be in the first state through the electrical signal, so that the optical switches in the first state obtain the first light beam based on the incident light 1912. At the same time, the optical switch corresponding to the pixel area 1910 (assuming that the non-reflection area corresponds to the pixel area 1910) is controlled to be in the second state through the electrical signal, so that the optical switch in the second state obtains the second light beam based on the incident light 1912. Both the first light beam and the second light beam are incident on the reflection layer 1902, the reflection layer 1902 reflects the first light beam and transmits the second light beam, and the light absorption layer 1901 absorbs the second light beam transmitted through the reflection layer 1902, so as to realize the display of a non-reflection area 2001 and a reflection area 2002 on the mirror display device. Note that, this is only an exemplary illustration, and should not impose any limitation on the embodiments of the present disclosure.

In a case where when the optical switch is in the second state, the incident light is blocked from being incident on the reflection layer, the implementation principles of the mirror display device in the power-on and power-off states are respectively described below in combination with a specific application scenario.

Referring to FIG. 21, the structure of the mirror display device (from left to right of the figure) may include a reflection layer 2101, a second polarizer 2102, a first substrate 2103, a first electrode layer 2104, a liquid crystal layer 2105, a second electrode layer 2106, a second substrate 2107 and a first polarizer 2108, and may further include a pixel area 2109, a pixel area 2110 and a pixel area 2111 distributed in an array and formed by the optical switch array.

In an application scenario, if the mirror display device is in the power-off state, the control module and the optical switch array in the mirror display device do not work, and in this case, optical switches corresponding to the pixel area 210), the pixel area 2110, and the pixel area 2111 are in the first state. The optical switch in the first state obtains the first light beam in the first polarization direction based on the incident light 2112, the first light beam in the first polarization direction is incident on the reflection layer 2101 after passing through the optical switch array and the second polarizer 2102 in the first polarization direction, and the reflection layer 2101 can reflect the first light beam that is in the first polarization direction. At this time, a target object 2113 in the current scene can view a mirror image 2114 on the mirror display device.

In another application scenario, if the mirror display device is in the power-on state, both the control module and the optical switch array in the mirror display device can normally work. The control module acquires the scene image containing the target object 2113 in the current scene, and the control module determines that the target object 2113 is not the preset object (for example, the preset object can be the vehicle, etc.) by determining the extracted contour of the target object. In this case, the control module can use the entire scene image including the target object 2113 as the reflection area, and control the optical switches corresponding to the pixel area 2109, the pixel area 2110 and the pixel area 2111 to be in the first state through the electrical signal. The optical switch in the first state obtains the first light beam in the first polarization direction based on the incident light 2112, the first light beam in the first polarization direction is incident on the reflection layer 2101 after passing through the optical switch array and the second polarizer 2102 in the first polarization direction, and the reflection layer 2101 can reflect the first light beam that is in the first polarization direction. At this time, the target object 2113 in the current scene can view the mirror image 2114 on the mirror display device. Note that, this is only an exemplary illustration, and should not impose any limitation on the embodiments of the present disclosure.

Referring to FIG. 22, for the description of the structure of the mirror display device, reference may be specifically made to the description in FIG. 21, which will not be repeated here.

In an application scenario, if the mirror display device is in the power-on state, both the control module and the optical switch array in the mirror display device can normally work. The control module acquires the scene image containing the target object 2113 in the current scene, and the control module determines that the target object 2113 is the preset object (for example, the preset object can be the target portrait, etc.) by determining the extracted contour of the target object. In this case, the control module can segment the non-reflection area from the scene image containing the target object 2113 based on the contour of the target object, and use the area in the scene image other than the non-reflection area as the reflection area. The optical switches corresponding to the pixel area 2109 and the pixel area 2111 (assuming that the reflection area corresponds to the pixel area 2109 and the pixel area 2111) are controlled to be in the first state through the electrical signal, so that the optical switches in the first state obtain the first light beam in the first polarization direction based on the incident light 2112. At the same time, the optical switch corresponding to the pixel area 2110 (assuming that the non-reflection area corresponds to the pixel area 2110) is controlled to be in the second state through the electrical signal, so that the optical switch in the second state obtains the second light beam in the second polarization direction based on the incident light 2112. When the first light beam and the second light beam reach the second polarizer 2102 that is in the first polarization direction, the first light beam can pass through the second polarizer 2102 and can be incident on the reflection layer 2101, since the polarization direction of the first light beam is the same as that of the second polarizer 2102. The reflection layer 2101 reflects the first light beam, so as to realize the display of the reflection area 2201 on the mirror display device. However, since the polarization direction of the second light beam in the second polarization direction does not match the second polarizer 2102 in the first polarization direction, the second light beam is blocked by the second polarizer 2102 and cannot be incident on the reflection layer, so as to realize the display of the non-reflection area 2202 on the mirror display device. At this point, the target object 2113 can view the mirror image 2114 on the mirror display device. Note that, this is only an exemplary illustration, and should not impose any limitation on the embodiments of the present disclosure.

In an embodiment of the present disclosure, there may be a gap or occlusion problem between the non-reflection area and the reflection area due to influence factors such as pixel-like aliasing at a juncture of the extracted non-reflection area and reflection area, leading to affecting the display effect of the non-reflection area in the mirror display device. Therefore, certain adjustments can be made to the obtained non-reflection area to remove possible gaps at the juncture of the non-reflection area and the reflection area. For example, the non-reflection area can be scaled to adjust the juncture of the non-reflection area and the reflection area. An area within a certain range at the juncture of the non-reflection area and the reflection area may be subjected to transition or halo processing to process the juncture between the non-reflection area and the reflection area in a transition manner.

Specifically, the area determination unit 903 may perform scaling processing on the obtained non-reflection area according to a preset scaling ratio, and determine an area other than the scaled non-reflection area as the reflection area.

The preset scaling ratio may refer to a scaling ratio preset by relevant personnel and used to adjust and optimize the non-reflection area. For example, the preset scaling ratio may be used to enlarge the entire non-reflection area by 5%, or may be used to reduce the entire non-reflection area by 5%. In addition, it is also possible that a part of the non-reflection area may be enlarged and a part of the non-reflection area may be reduced, which is not specially limited in the embodiments of the present disclosure.

In addition, the area within a certain range at the juncture of the non-reflection area and the reflection area may also be subjected to the transition or halo processing to adjust and optimize the juncture of the non-reflection area and the reflection area. Furthermore, the mirror display device can also realize the transition or halo processing for the juncture of the non-reflection area and the reflection area through the following steps S2310 to S2320.

Referring to FIG. 23, in the step S2310, a transition area between the reflection area and the non-reflection area is determined by the area determination unit 903 according to a preset pixel length.

In the step S2320, an optical switch of a first portion in the transition area is controlled to be in the first state and an optical switch of a second portion in the transition area is controlled to be in the second state by the control module 103.

The preset pixel length may refer to preset data used to determine a range of the transition area between the reflection area and the non-reflection area. For example, the preset pixel length may be a 5-pixel length or a 10-pixel length, which can be specifically customized according to an actual situation, and which is not specially limited by the embodiments of the present disclosure. The transition area may refer to an area that corresponds to the contour of the non-reflection area and within a preset pixel length range. For example, the transition area may be an annular area or a semi-enclosed area within the 5-pixel length around the contour of the non-reflection area, or it may be an annular area or a semi-enclosed area within the 10-pixel length around the contour of the non-reflection area.

Further, after the transition area is determined, the optical switches of the first portion in the transition area can be controlled to be in the first state, the optical switches of the second portion in the transition area can be controlled to be in the second state, and the optical switches of the first portion and the optical switches of the second portion can be alternately distributed in the transition area, so as to realize the transitional display or the halo display of the transition area.

In an embodiment of the present disclosure, the mirror display device can be applied to a public place as a smart entertainment device that can interact with people; it can also be used as a rearview mirror of a vehicle to highlight the target object (such as a vehicle) in a scene with a large change in the light intensity, so as to assist the driver in determining a vehicle condition and improve the driving safety. Note that, the mirror display device can also be used in most scenarios where the reflection area and the non-reflection area are distinctively displayed, and the embodiment of the present disclosure does not specially limit the application scenario of the mirror display device.

It should be noted that although several modules or units of the device that are configured to perform actions are mentioned in the above detailed description, such division of modules or units is not mandatory. In fact, features and functions of two or more of the modules or units described above may be embodied in one module or unit in accordance with the embodiments of the present disclosure. Conversely, the features and functions of one module or unit described above may be further divided into multiple modules or units.

In addition, in the embodiments of the present disclosure, there is further provided a method for displaying an image, and the method for displaying the image may include the following steps:

determining a reflection area and a non-reflection area of a mirror display device according to an acquired scene image;

controlling an optical switch corresponding to the reflection area to be in a first state to obtain a first light beam based on incident light;

controlling an optical switch corresponding to the non-reflection area to be in a second state different from the first state; and

receiving and reflecting, by a reflection layer, the first light beam incident on the reflection layer.

In some embodiments of the present disclosure, based on the foregoing solution, the method for displaying the image further includes:

obtaining a second light beam based on the incident light when the optical switch is in the second state;

receiving and transmitting, by the reflection layer, the second light beam incident on the reflection layer.

In some embodiments of the present disclosure, based on the foregoing solution, the method for displaying the image further includes:

blocking, by the optical switch, the incident light from being incident on the reflection layer, when the optical switch is in the second state.

In some embodiments of the present disclosure, based on the foregoing solution, the mirror display device further includes a light absorption layer, and the method for displaying the image further includes:

absorbing, by the light absorption layer, the second light beam transmitted through the reflection layer.

In some embodiments of the present disclosure, based on the foregoing solution, the method for displaying the image further includes:

acquiring the scene image corresponding to a current scene:

extracting a contour of a target object from the scene image; and

determining the reflection area and the non-reflection area in the mirror display device according to the contour of the target object.

In some embodiments of the present disclosure, based on the foregoing solution, the method for displaying the image further includes:

performing image subtraction processing on the scene image to obtain a foreground image and a background image corresponding to the scene image; and

extracting the contour of the target object corresponding to the scene image from the foreground image.

In some embodiments of the present disclosure, based on the foregoing solution, the method for displaying the image further includes:

acquiring a preset background model, and the background model includes a preset image that corresponds to the current scene and does not contain the target object; and

performing background subtraction processing according to the scene image and the preset image to obtain the foreground image and the background image corresponding to the scene image.

In some embodiments of the present disclosure, based on the foregoing solution, the method for displaying the image further includes:

detecting boundary points in the foreground image; and

extracting the contour of the target object corresponding to the scene image according to the connected boundary points.

In some embodiments of the present disclosure, based on the foregoing solution, the method for displaying the image further includes:

detecting and extracting a key point from the scene image according to the contour of the target object;

performing semantic segmentation on the scene image according to the extracted key point to obtain the non-reflection area; and

determining an area in the scene image other than the non-reflection area as the reflection area.

In some embodiments of the present disclosure, based on the foregoing solution, the method for displaying the image further includes:

performing scaling processing on the obtained non-reflection area according to a preset scaling ratio, and determining an area other than the scaled non-reflection area as the reflection area.

In some embodiments of the present disclosure, based on the foregoing solution, the method for displaying the image further includes:

determining a transition area between the reflection area and the non-reflection area according to a preset pixel length;

controlling an optical switch of a first portion in the transition area to be in the first state; and

controlling an optical switch of a second portion in the transition area to be in the second state.

The method for displaying the image can be implemented by the mirror display device in the embodiments of the present disclosure, and can also be implemented by other similar mirror display devices. For example, the mirror display device in the embodiments of the present disclosure adopts a transmissive optical switch array, but based on the similar principle, a mirror display device including a reflection optical switch array can also implement the method for displaying the image. Therefore, the device for implementing the method for displaying the image is not specially limited by the embodiments of the present disclosure.

In addition, specific details of each step in the method for displaying the image have been described in detail in the corresponding mirror display device, and thus will not be repeated here. Furthermore, although various steps of the method of the present disclosure are described in a particular order in the figures, it is not required or implied that these steps must be performed in the particular order, or all of the illustrated steps must be performed to achieve the desired result. Additionally or alternatively, some of the steps may be omitted, or multiple steps may be combined into one step to be performed, and/or one step is decomposed into multiple steps to be performed.

In addition, in the embodiments of the present disclosure, there is further provided an electronic device capable of implementing the method for displaying the image.

Those skilled in the art can understand that various aspects of the present disclosure may be implemented as systems, methods, or program products. Therefore, various aspects of the present disclosure may be embodied as complete hardware embodiments, complete software embodiments (including firmware, microcode, etc.), or embodiments with hardware and software combined, which may be collectively referred to as “circuits”, “modules” or “systems” here.

An electronic device 2400 according to the embodiments of the present disclosure is described below with reference to FIG. 24. The electronic device 2400 shown in FIG. 24 is only an example and shall not impose any restrictions on the function and scope of application of the embodiments of the present disclosure.

As shown in FIG. 24, the electronic device 2400 is represented in the form of a general-purpose computing device. Components of the electronic device 2400 may include, but are not limited to, at least one processing unit 2410, at least one storage unit 2420, a bus 2430 connecting different system components (including the storage unit 2420 and the processing unit 2410), and a display unit 2440.

The storage unit is stored with program codes which, when executed by the processing unit 2410, cause the processing unit 2410 to perform the steps according to various embodiments of the present disclosure described in the “exemplary method” described above in the specification. For example, the processing unit 2410 may perform the following steps:

determining the reflection area and the non-reflection area of the mirror display device according to the acquired scene image; controlling the optical switch corresponding to the reflection area to be in the first state to obtain the first light beam based on the incident light; controlling the optical switch corresponding to the non-reflection area to be in the second state different from the first state; and receiving and reflecting, by the reflection layer, the first light beam incident on the reflection layer.

The storage unit 2420 may include a readable medium in the form of volatile storage unit, such as a random access memory (RAM) 2421 and/or a cache storage unit 2422, and it may further include a read-only memory (ROM) 2423.

The storage unit 2420 may also include a program/utility tool 2424 having a set of (at least one) program module 2425. Such program module 2425 includes, but is not limited to, an operating system, one or more applications, other program modules, and program data, each or a combination of the examples may include the implementation of a network environment.

The bus 2430 may be one or more of several types of bus structures, including a storage unit bus or a storage unit controller, a peripheral bus, an accelerated graphics port, a processing unit, or a local bus using any of the bus structures.

The electronic device 2400 may also communicate with one or more external devices 2470 (e.g., a keyboard, a pointing device, a Bluetooth device), or may communicate with one or more devices that enable the user to interact with the electronic device 2400, and/or communicate with any device (e.g., a router, a modem, etc.) that enables the electronic device 2400 to communicate with one or more other computing devices. The communication may be carried out through an input/output (I/O) interface 2450. Moreover, the electronic device 2400 may also communicate with one or more networks (such as a Local Area Network (LAN), a Wide Area Network (WAN) and/or a public network, e.g. Internet) via a network adapter 2460. As shown in the figure, the network adapter 2460 communicates with other modules of the electronic device 2400 via the bus 2430. It should be noted that although not shown in the figure, other hardware and/or software modules may be used in conjunction with the electronic device 2400, including, but not limited to, a microcode, a device driver, a redundancy processing unit, an external disk drive array, an RAID system, a tape drive, and a data backup storage system.

Through the description of the above-mentioned embodiments, it is easy for those skilled in the art to understand that the exemplary embodiments described here may be implemented by software or by software in combination with necessary hardware. Therefore, the technical solution of the embodiments of the present disclosure may be embodied in the form of a software product which may be stored in a non-volatile storage medium (which may be a CD-ROM, a USB flash disk, or mobile hard disk) or on a network and which may include several instructions to enable a computing device (which may be a personal computer, a server, a terminal device, or a network device) to implement the method according to the embodiments of the present disclosure.

In the embodiments of the present disclosure, there is further provided a computer-readable storage medium stored thereon with a program product capable of implementing the method described above in the specification. In some possible embodiments, various aspects of the present disclosure may also be implemented in the form of a program product, which includes program codes. When the program product is running on a terminal device, the program codes is configured to cause the terminal device to perform the steps according to various embodiments of the present disclosure described in the “exemplary methods” described above in the specification.

Referring to FIG. 25, a program product 2500 for implementing the method for displaying the image according to an embodiment of the present disclosure is described. The program product 2500 may use a portable compact disk read-only memory (CD-ROM), and include program codes, and may be running on a terminal device, such as a personal computer. However, the program product of the present disclosure is not limited to this. In this document, a readable storage medium may be any tangible medium containing or storing a program, which may be used by or used in combination with an instruction execution system, apparatus, or device.

The program product may adopt any combination of one or more readable mediums. The readable medium may be a readable signal medium or a readable storage medium. The readable storage medium may be, for example, but not limited to, electrical, magnetic, optical, electromagnetic, infrared, or semiconductor systems, apparatuses or devices, or any combination thereof. More specific examples (non-exhaustive list) of the readable storage medium include: electrical connections with one or more wires, a portable disk, a hard disk, a random access memory (RAM), a read-only memory (ROM), an erasable programmable read-only memory (EPROM or flash), an optical fiber, a portable compact disk read-only memory (CD-ROM), an optical storage device, a magnetic storage device, or any suitable combination thereof.

A computer-readable signal medium may include a data signal transmitted in a baseband or as part of a carrier, which carries a readable program code. The transmitted data signal may be represented in many forms, including, but not limited to, an electromagnetic signal, an optical signal, or any suitable combination thereof. The readable signal medium may also be any readable medium other than the readable storage medium, which may send, propagate, or transmit programs which are used by, or used in conjunction with an instruction execution system, apparatus, or device.

Program codes contained on the readable medium may be transmitted with any appropriate medium, which includes, but is not limited to, wireless, wired, an optical cable, RF, etc., or any suitable combination thereof.

Program codes for performing an operation of the present disclosure may be written in any combination of one or more programming languages, which include object-oriented programming languages such as Java, C++, conventional procedural programming languages such as “C” language or similar programming languages. The program codes may be executed entirely on a user computing device, partially on a user device, as a separate software package, partially on a user computing device and partially on a remote computing device, or entirely on a remote computing device or a server. In the case where the remote computing device is involved, the remote computing device may be connected to the user computing device through any kind of network, including a Local Area Network (LAN) or a Wide Area Network (WAN), or may be connected to an external computing device (for example, connected through the internet by using an internet service provider).

In addition, the above-mentioned drawings are only schematic illustrations of processes included in the method according to the embodiments of the present disclosure, and are not restrictive of the present disclosure. It is easily understood that the processes shown in the above-mentioned drawings do not indicate or limit a chronological order of the processes. It is also easily understood that the processes may be performed synchronously or asynchronously, for example, in a plurality of modules.

Through the description of the above embodiments, those skilled in the art will readily understand that the exemplary embodiments described here may be implemented by software or by software in combination with necessary hardware. Therefore, the technical solution according to the embodiments of the present disclosure may be embodied in a form of software product, which may be stored in a non-volatile storage medium (which may be a CD-ROM, a USB disk, a mobile hard disk, etc.) or on a network, including a number of instructions to make a computing device (which may be a personal computer, a server, a touch terminal, or a network device, etc.) to perform the methods according to the embodiments of the present disclosure.

Other embodiments of the present disclosure will be apparent to those skilled in the art from consideration of the specification and practice of the present disclosure disclosed here. The disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It should be understood that the present disclosure is not limited to the precise structures that have been described above and shown in the drawings, and various modifications and changes can be made without departing from the scope thereof. The scope of the present disclosure is limited only by the appended claims.

1. A mirror display device, comprising:
an optical switch array, comprising a plurality of optical switches configured to obtain, in a first state, a first light beam based on incident light;
a reflection layer, disposed on a side of the optical switch array, and configured to receive and reflect the first light beam incident on the reflection layer; and
a controller, configured to determine a reflection area and a non-reflection area, and control an optical switch corresponding to the reflection area to be in the first state and an optical switch corresponding to the non-reflection area to be in a second state different from the first state.

2. The mirror display device according to claim 1, wherein:
the optical switches are further configured to obtain, in the second state, a second light beam based on the incident light; and
the reflection layer is further configured to receive and transmit the second light beam incident on the reflection layer.

3. The mirror display device according to claim 1, wherein the optical switch array comprises:
an array substrate, comprising a plurality of pixel areas distributed in an array, wherein an electric field of each pixel area is controlled by the controller; and
a liquid crystal layer, distributed in each pixel area, wherein liquid crystal in each pixel area is configured to perform a first deflection according to the electric field to form an optical switch in the first state, and perform a second deflection to form an optical switch in the second state.

4. The mirror display device according to claim 3, wherein the mirror display device further comprises:
a polarizer, disposed on an optical path along which the incident light is incident on the optical switch array, and configured to obtain a polarized light beam;
wherein when the liquid crystal in a first deflection state is passed through by the polarized light beam, the first light beam in a first polarization direction is obtained; and
when the liquid crystal in a second deflection state is passed through by the polarized light beam, the second light beam in a second polarization direction is obtained.

5. The mirror display device according to claim 4, wherein the reflection layer is a transflective layer, and the transflective layer is configured to reflect the light beam in the first polarization direction, and transmit the light beam in the second polarization direction.

6. The mirror display device according to claim 3, wherein the array substrate comprises:
a first substrate;
a second substrate, disposed opposite to the first substrate; and
an electrode layer, electrically coupled with the controller and disposed on the first substrate and/or the second substrate.

7. The mirror display device according to claim 6, wherein the array substrate is a transparent substrate, and the electrode layer is a transparent electrode layer.

8. The mirror display device according to claim 2, wherein the mirror display device further comprises:
a light absorption layer, disposed on an optical path of the second light beam transmitted through the reflection layer, and configured to absorb the second light beam transmitted through the reflection layer.

9. The mirror display device according to claim 1, wherein:
the optical switches are further configured to block, in the second state, the incident light from being incident on the reflection layer.

10. The mirror display device according to claim 9, wherein the mirror display device further comprises:
a first polarizer, disposed on an optical path along which the incident light is incident on the optical switch array, and configured to obtain a polarized light beam;
wherein when liquid crystal in a first deflection state is passed through by the polarized light beam, the first light beam in a first polarization direction is obtained; and
when the liquid crystal in a second deflection state is passed through by the polarized light beam, a second light beam in a second polarization direction is obtained; and
a second polarizer, disposed on an optical path along which the first light beam is incident on the reflection layer, wherein a polarization direction of the second polarizer is the first polarization direction and is configured to block the light beam in the second polarization direction from being incident on the reflection layer.

11. The mirror display device according to claim 1, wherein the controller is configured to:
acquire a scene image corresponding to a current scene;
extract a contour of a target object from the scene image; and
determine the reflection area and the non-reflection area according to the contour of the target object.

12. The mirror display device according to claim 11, wherein the controller is further configured to:
perform image subtraction processing on the scene image to obtain a foreground image and a background image corresponding to the scene image; and
extract the contour of the target object corresponding to the scene image from the foreground image.

13. The mirror display device according to claim 12, wherein the controller is further configured to:
store a preset background model, wherein the background model comprises a preset image corresponding to the current scene that does not contain the target object; and
wherein the controller is specifically configured to perform background subtraction processing according to the scene image and the preset image to obtain the foreground image and the background image corresponding to the scene image.

14. The mirror display device according to claim 12, wherein the controller is further configured to:
detect boundary points in the foreground image; and
extract the contour of the target object corresponding to the scene image according to connected boundary points.

15. The mirror display device according to claim 11, wherein the controller is further configured to:
detect and extract a key point from the scene image according to the contour of the target object;
perform semantic segmentation on the scene image according to the extracted key point to obtain the non-reflection area; and
determine an area in the scene image other than the non-reflection area as the reflection area.

16. The mirror display device according to claim 11, wherein the controller is further configured to:
perform scaling processing on the determined non-reflection area according to a preset scaling ratio, and determine an area other than the scaled non-reflection area as the reflection area.

17. The mirror display device according to claim 11, wherein the controller is further configured to:
determine a transition area between the reflection area and the non-reflection area according to a preset pixel length; and
control an optical switch corresponding to a first portion in the transition area to be in the first state, and control an optical switch corresponding to a second portion in the transition area to be in the second state.

18. A method for displaying an image, applied to a mirror display device comprising a plurality of optical switches and a reflection layer, and comprising:
determining a reflection area and a non-reflection area of the mirror display device according to an acquired scene image;
controlling an optical switch corresponding to the reflection area to be in a first state to obtain a first light beam based on incident light;
controlling an optical switch corresponding to the non-reflection area to be in a second state different from the first state; and
receiving and reflecting, by the reflection layer, the first light beam incident on the reflection layer.

19. The method for displaying the image according to claim 18,
wherein the method for displaying the image further comprises:
obtaining a second light beam bean based on the incident light when the optical switches are configured to be in the second state; and
receiving and transmitting, by the reflection layer, the second light beam incident on the reflection layer.

20. The method for displaying the image according to claim 18, wherein the method for displaying the image further comprises:
blocking, by the optical switches, the incident light from being incident on the reflection layer when the optical switches are configured to be in the second state.

21.-30. (canceled)
